(19) United States
(12) Patent Application Publication
(10) Pub. No.: US 2003/0179229 A1
(43) Pub. Date: Sep. 25, 2003

(54) Biometrically-determined device interface and content

(76) Inventors: Julian Van Erlach, Clifton Park, NY (US); Auzim Sultan, Albany, NY (US)

Correspondence Address: Julian Van Erlach, 17-15 Hunt Ridge Dr., Clifton Park, NY, 12065, US

(21) Appl. No.: 10/396,669

(22) Filed: Mar. 25, 2003

Related U.S. Application Data
(60) Provisional application No. 60/389,403, filed on Jun. 18, 2002.
(60) Provisional application No. 60/367,098, filed on Mar. 25, 2002.

(51) Int. Cl. G09G 5/00

(52) U.S. Cl. 345/744

(57) ABSTRACT

Method and system for automatically determining a user interface configuration, operation and content of a computing or telecommunication device based upon user biometrics. The invention teaches a method of capturing and determining at least one user biometric based upon which, a logic engine determines the appearance or configuration apparent to the user of a user interface, the means of operation of such interface, and the content provided to such interface. Biometrics may be other than those needed or used for determining the identity of a user. A device may be a computer, a wireless device including an instrument or communication device, a television, a kiosk or a vehicle equipped with biometric sensing and computing devices. The invention pertains to providing biometrically-driven, customizable user interfaces and content for such items as kiosks, communication devices, Internet-interactive devices, electronic signs and digital television that are equipped or networked with biometric data capture means. Thus, devices may be reconfigured automatically to better suit the age, sex, physical and other attributes of user in their interaction with a device without active provision of information by a user.

### REFERENCE CITED

This application claims benefit of priority from provisional applications Nos. 60/389,403 and 60/367,098 filed by one or both inventors named.

### STATEMENT REGARDING FEDERALLY-SPONSERED RESEARCH AND DEVELOPMENT

The specification hereunder was not conceived or developed in the course of, as a result of, or in association with any Federal, state or local research and development sponsorship.

### DESCRIPTION

1. Technical Field

The invention relates generally to methods and apparatus for capturing, digitally processing and performing a computerized function by a device as a consequence of biometric user parameters.

2. Description of Prior Art

Current uses of biometrics as relating to computing and communicating devices relate primarily to security via identity verification means. These means compare captured digital representations of a user or sensed biometric to a database of like biometrics associated with identities of persons or animals. Mathematical parameters are established for determining the probability of a match between a sensed and digitally represented biometric with the database version linked to an identity. Further biometric uses pertain to machine vision and context or meaning engines which for example, may compare the actions of persons captured on digital images to a context engine operatively designed to determine the probability that such actions represent violence, illness or other states requiring some action on the part of authorities or similar regulatory body.

### SUMMARY OF THE INVENTION

The invention discloses a method of automatically modifying a user interface, operation of an interface and content served to an interface based upon capture of one or more user biometrics which need not pertain to specific user identity. User interfaces of computing and telecommunication devices include computers, telephones, televisions, kiosks, PDAs, vehicles equipped with computing capability, digital instruments and many other devices similarly equipped. The invention teaches that the means and content of interaction between a user and such devices may optimally vary automatically based upon user biometrics. A kiosk touched by a little girl's finger may configure its means of interaction and content differently from a touch by a man's finger when determined by appropriate biometric capture and discrimination means. Machine verbal communication systems may simplify their syntax when sensing a child's voice as compared to an adult; or prioritize human interaction if stress is sensed in a human voice. A vehicle may not allow operation when controlled by a child. A digital television system may select and serve digital advertisements suitable for the physical composition of the audience sensed in front of it: for number, age, sex, body mass or body size, for example. The ads seen by a web user may be served based on certain user biometrics captured by the device used. Contents of a smart sign may be altered based on biometrics of passersby.

### DETAILED DESCRIPTION OF DRAWINGS AND PREFFERED EMBODIMENTS

A more complete understanding of the method and apparatus of the present invention may be had by reference to the following detailed description when taken in conjunction with the accompanying drawings wherein the diagrams disclose the functions and systems necessary to provide said methods and services. However, it is understood that this class of embodiments provides only a few examples of the many advantageous uses of the innovative teachings herein. In general, statements made in the specification of the present application do not delimit any of the various claimed inventions. Moreover, some statements may apply to some inventive features but not to others.

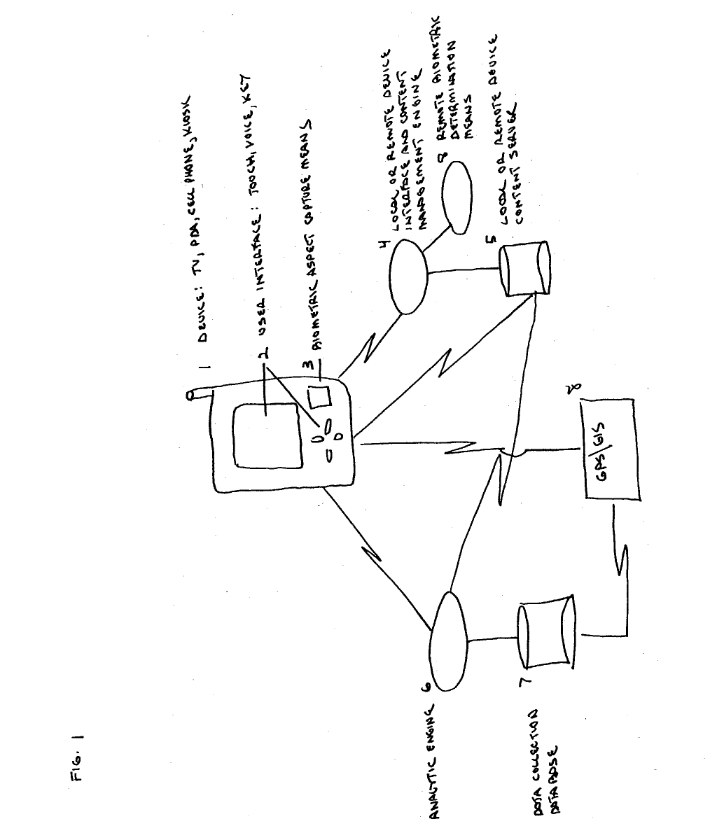

FIG. 1: in one aspect, the depicted device (1) may be a fixed position, or mobile kiosk device enabled to determine one or more user biometrics such as fingerprint, body mass, facial spatial characteristics, retinal scan, or voice. Upon a user's touch or interaction with the kiosk interface (2), the fingerprint is captured and digitally rendered by a biometric capture and determination means (3) which may be integrated with the user touchscreen interface. Remotely or locally, a logic engine and related interface and content management engine (4) determines based upon fingerprint metrics and patterns and associated tables or templates, the approximate sex and age of the user. Upon determination of this data from the fingerprint, the device interface and content manager instructs a local or remote content server (5) so as to alter the configuration of the device user interface and/or its content. If the user is a female child, the interface manager (4) may alter the configuration of the device interface; which is to say the location and style of its touch-responsive areas; and may direct the display of information including text, graphics, video, audio and tactile content that an application, programmer or system manager has deemed should be served upon the sensing of touch by a female child by managing the content supplied by the content server (5). Thus the kiosk interface becomes “child-friendly” when touched by a child, and adult male or female customized for its content, style, and means of interaction depending upon the determined user biometrics. Based upon the use of said device over a period of time—cached local or remotely stored content can be further tailored to deliver information specifically tailored for a portion of the demographic market. For example if over the course of several days or weeks the device in question is interacted with predominantly by female children within an age range of 5 to 10; the device content delivery application may deliver a general category of content aimed at that target demographic group. Moreover the application interface may be altered by an application, programmer or system manager to present a more “child friendly” user interface based on the device's user demographic base over a period of time.

In another aspect, the invention FIG. 1 may be a wireless communication and computing device (1). A child placing an emergency 911 call through the user interface (2) and communicating with a computerized call and voice management system is sensed to be a stressed child by a remote device interface and content management engine (4) and associated remote biometric (in this case voice analysis) engine (8). Based on the child and stress determination by the biometric engine, simplified computer voice syntax and soothing tone may be directed from the (automated voice) content server (5) by the device interface manager (4); while simultaneously prioritizing human call intervention. Human call intervention may be further supplied with GIS or GPS-location (8) of said device and the fact that the caller is a child with a highly stressed voice or third party intervention service ties to existing police or regulatory body GIS or GPS systems.

In another aspect, the device (1) may be a digital television equipped or networked with a biometric aspect determination means (3) that employs a means (such as infrared laser, thermal imaging, RADAR, digital camera or acoustic means) to ascertain the number and size of persons within viewing range of said television. A logic engine and device interface and content manager (4) determines that said user biometrics are likely to be a mixed group of children and directs a content server (5) (advertising server, in this case) to place ads programmed for this demographic at an appropriate time. If the digital television system, including WEBTV, is further equipped with a user interaction or commerce conduct means, then user interaction with the system may be captured as well as user demographics and stored in a data collection database (7). The Invention teaches a combination of a biometric-determining device such as a energy beam scanner or digital camera with an ad server database, an intelligent ad router and an ad compressor and decompression engine. The platform and system enables the serving of ads to persons deemed to be within an area of ad exposure based upon their biometric characteristics. A cable television converter unit may be coupled, for example, with an infrared scanner or digital camera capable of discerning the size, sex and approximate age of persons within a designated vicinity of the television. This information is supplied to an intelligent router which selects ads from a database on an ad server whose designated target audience, time slot, television show characteristics and other parameters match those of input from each properly equipped biometric data gathering unit. Selected ads are compared for time length to available or given time in the ad slot and a digital ad compression and decompression engine runs the ad to fit the assigned time. Any device used for conveying ads visually, through audio or other means may be so coupled with biometric data-gathering devices, said intelligent ad router and an ad database comprised of digital ads containing machine-readable instruction regarding desired audience characteristics which are then matched in part with data from the Invention and served when a logic routine deems an appropriate match has been made.

The ad delivery mechanism may also be locally augmented by user input to display specified content on a pay per view basis, or remunerate per view basis whereby user may select an option to view specified content that requires input or follow-up on completion. A post input action would either create, credit or debit a user account associated with a locally or remotely existing new or proprietary third party stored user tracking mechanism such as MS passport or SUN One.

In the cases of all of the above examples, data about user biometrics, device interaction and commerce patterns, device location and time, and other data may be aggregated in a data collection database (7). Analytic engine (6) acting upon the data in the database (7) may be employed to determine refinements in device user interface means and content. For example, if the device (1) is a mall kiosk, and the analytic engine (6) determines that 80% of users are male children, then the default content of the kiosk may be directed toward that demographic. In the case of a digital television system equipped with user biometric capture means; the effectiveness of ads served based on user biometrics may be compared to those without use of said biometrics. Further, audience demographics may be computed according to content served (e.g. shows) and time of day as well as geographic location.

1. A computerized means of automatically altering the configuration, content and operation of a user interface to a computing or telecommunication device upon determination of at least one user biometric data; comprising:
1.1 a means, integrated or networked with a user device, of obtaining at least one user biometric, including but not limited to: a fingerprint, a voice print, voice spectrum scan, transmission voltage scan, retinal scan, facial metrics, dermal or sub-dermal scan, thermal scan, body dimension or mass analysis, molecular, cellular or sub-cellular matter obtained from a person or animal, or conveyance of biometric aspect by a second device to a first device.
1.2 a means of determining an approximate age and sex of a user from at least one obtained biometric
1.3 a means of determining an emotional state of a user from at least one obtained user biometric
1.4 at least one user device including but not limited to: a television, a computer, a communication device, a kiosk, or digital instrument associated with thin or thick client delivery
1.5 at least one user device interface including, but not limited to: a touchscreen, a keypad, a voice interface, a viewable surface, an interface operable by the eye movement of a user, an interface operated by a wireless device in possession of a user
1.6 at least one user device interface configuration, operation and content control engine enabled to modify the device user interface configuration, means of operation and content based at least in part on at least one user biometric
1.7 at least one content server operatively networked with said user device, user interface, biometric capture means, biometric determination means, and device interface and content control engine
1.8 at least one network comprising one or more: user devices; biometric capture means; content server; interface configuration, operation and content management engine; database or array of geospatial or determination information, database of network transactions;

2. A method of claim 1 that is enabled to identify the user.

3. A method of claim 1 that is operable through at least one of: the Internet, an Intranet, local area network (LAN), Wide area network (WAN), Metropolitan area network (MAN) or similar wireless data delivery network.

4. A method of claim 1 wherein any or all of the biometric determination means, the device interface, content control engine, content server and associated database or data analysis components are located locally, remotely or a combination thereof from the user device.

5. A method of claim 1 where, as a consequence of a user biometric, a user interface of a device is altered by an interface management engine regarding at least one of: an aspect of the interface visual appearance, interface functionality, interface content.

6. A method of claim 1 where the content, configuration or means of operation of an interface to a user device is altered based on a historic pattern of user biometrics associated with a given device or device category.

7. A method of claim 1 where a device dispenses a physical article to a user based on at least one user biometric operatively captured and analyzed by a means associated with said device

8. A method of claim 1 where user interactions with, and transactions conducted through said device are archived and analyzed in relation to user biometric information

9. A method of claim 1 where content is provided to a device interface based at least in part on at least one user biometric and patterns of historic device usage by users with similar biometrics

10. A method of claim 1 where a device and analytic engine obtain and compare an obtained user biometric to stored biometrics, locally or remotely, resulting in a positive or near positive identification as a consequence of which, said device or a remote processing location references prior archived user transaction or other activity patterns and employs logic functions to alter an aspect of said user interface including appearance, function, content and method of interaction with said user

11. A method of claim 1 where biometric data obtained from a plurality of user interactions with a plurality of devices is archived and is compared with an obtained user biometric from current activity with a device resulting in a positive or near positive identification as a consequence of which, said device or a remote processing location references prior user transaction or other archived activity patterns and employs logic functions to alter an aspect of said user interface including appearance, function, content and method of interaction with said user

12. A method of claim 1 wherein a multiple user biometric composite profile is compiled over time for a single device, a group or category of devices or by geographic region where devices are located; where said profile is further comprised of at least one of: user biometric archived data, user device interaction patterns, times of interaction, transactions conducted through said devices.

13. A method of claims 1, 12 wherein biometric demographic profiles of individual devices, including fixed location devices such as kiosks, or device types such as PDAs, are employed to configure, manage and alter the interface or content of said devices by at least one of: region, time of day, season of year

14. A method of claim 1 comprising at least one of the steps of: comparing at least one obtained user biometric from a device to archived biometrics of law enforcement agencies; determining a degree of match between said biometrics; notifying at least one regulatory body or law enforcement agency or person of said match and location of said device; providing information about the subject of said biometric match to a regulatory body, law enforcement agency or agent

15. A method of claim 1 where said device is comprised of at least two of: a television or computing or telecommunication device integrated or networked with: a biometric capture means, an intelligent ad router engine capable of routing digital ads to a specific television at least in part based on viewer biometrics, a digital content server controlled in part by said intelligent ad router, a database archive enabled to archive said network activity.

16. A method of claim 1 where ad conveyance means include at least one of: television, radio, smart signs, PDAs, personal computing devices, personal computing and telecommunications devices including wireless devices, devices implanted on or within persons or animals and capable of inducing perception.

17. A method of claim 1 where said biometric data-gathering means include, but are not limited to: scanners utilizing energy beams such as infrared, radar, acoustic, digital cameras, heat sensors, wireless readers of identifying data from other wireless devices relating to user demographics, and other means capable of wireless biometric data acquisition.

18. A method of claims 1, 15 where biological parameter reading devices upon, near or implanted within a potential audience member are enabled to communicate one or more biological parameters of said member to said intelligent ad server platform.

19. A method of claim 1 where an ad database is indexed according to desired biometric criteria of a desired audience for each ad or ad type.

20. A method of claim 1 where said serving is correlated to electronic responses of an audience through an electronic response system

21. A method of claim 1 where a fee is charged or value is otherwise required to serve ads according to biometric parameters of a potential audience.

22. A method of claims 1, 15 where said intelligent content router contains logic rules concerning the serving of ads according to biometric and other audience parameters and ad or ad type desired audience criteria that may be located in said ad database and associated with each ad or ad types.

23. A method of claims 1, 15 where said platform is further coupled with an engine capable of digital ad time compression and decompression so that, among other capabilities, ads may be tailored to fit designated time slots.

24. A method of claims 1, 15 where said audience biometric parameters are part of a vector(s) comprising other parameters utilized for determining which ad or type of content to serve to an ad or content conveyance device.

25. A method of claims 1, 15 where network-wide biometrically determinable audience characteristics are gathered, aggregated, analyzed, reported, or utilized to perform a function; where said aggregation is at least one of: by geographic region, by time of day, by day of week, by season, by pre-determined or categorically associated user profile demographics, or by program in play or that had been played in front of a biometrically assessed audience.

26. A method of claim 1 where purchase and other transaction activity through or in conjunction with a node where audience biometric data has been gathered is correlated to said biometric data and utilized to modify an aspect of content served to a specific node or multiple nodes.

27. A method of claims 1, 15 wherein a biometric profile is established for each member of an audience, such as a household audience, and wherein said member's viewing exposure and transaction patterns are stored and associated with said member for the purpose of serving content or other member-customizable functions when said profile is readable by or conveyed to an intelligent content or ad serving engine.

28. A method of claim 1 where at least one local or network associated GIS or GPS data application or mechanism provides specific content delivery based on at least one captured biometric
